(19) United States
(12) Patent Application Publication
(10) Pub. No.: US 2026/0066418 A1
(43) Pub. Date: Mar. 5, 2026

(54) BATTERY ARRAY END PLATE DESIGNS

(71) Applicant: FORD GLOBAL TECHNOLOGIES, LLC, Dearborn, MI (US)

(72) Inventors: Jie Deng, Novi, MI (US); Sangyeon Kim, Northville, MI (US); Brian Utley, Canton, MI (US); Daniel Paul Roberts, Livonia, MI (US)

(21) Appl. No.: 18/816,637

(22) Filed: Aug. 27, 2024

(51) Int. Cl. H01M 50/233; H01M 50/249; H01M 50/262

(52) U.S. Cl. CPC H01M 50/233; H01M 50/249; H01M 50/262

(57) ABSTRACT

Battery array end plate designs are disclosed for use within traction battery packs. An exemplary battery array of the traction battery pack may include features that facilitate a battery array assembly process. These features include channels for accommodating a compression fixture, interlocking features (ribs, bumps, pins, etc.) for engaging corresponding features of an array housing, and angled walls for compressing an upper portion of a cell stack during the battery array assembly process.

### TECHNICAL FIELD

This disclosure relates generally to electrified vehicle traction battery packs, and more particularly to battery array end plate designs that facilitate a battery array assembly procedure.

### BACKGROUND

An electrified vehicle includes a traction battery pack for powering electric machines and other electrical loads of the vehicle. The traction battery pack includes a plurality of battery cells and various other battery internal components that support electric vehicle propulsion.

### SUMMARY

A battery array for a traction battery pack according to an exemplary aspect of the present disclosure incudes, among other things, an array housing and a cell stack housed within the array housing and including a plurality of battery cells arranged between a first end plate and a second end plate. Each of the first end plate and the second end plate includes a channel configured to receive a compression fixture.

In a further non-limiting embodiment of the foregoing battery array, the first end plate establishes an interface between a draft angle of a wall of the array housing and the cell stack.

In a further non-limiting embodiment of either of the foregoing battery arrays, the first end plate includes a first side face that interfaces with the wall, and a second side face that interfaces with a first battery cell of the plurality of battery cells.

In a further non-limiting embodiment of any of the foregoing battery arrays, the first side face includes a first profile and the second side face includes a second, different profile.

In a further non-limiting embodiment of any of the foregoing battery arrays, the first profile is sloped or angled, and the second, different profile is flat.

In a further non-limiting embodiment of any of the foregoing battery arrays, the channel is formed in the first side face of the first end plate.

In a further non-limiting embodiment of any of the foregoing battery arrays, the first side face includes a first angled surface and a second angled surface that converge together at an apex of the first side face.

In a further non-limiting embodiment of any of the foregoing battery arrays, the channel spans across the first angled surface and the second angled surface.

In a further non-limiting embodiment of any of the foregoing battery arrays, the first side face includes a first interlocking feature that is configured to engage a second interlocking feature of the wall.

In a further non-limiting embodiment of any of the foregoing battery arrays, the first interlocking feature is a raised ledge.

In a further non-limiting embodiment of any of the foregoing battery arrays, the first interlocking feature is a rib.

In a further non-limiting embodiment of any of the foregoing battery arrays, the first interlocking feature is a dimple.

In a further non-limiting embodiment of any of the foregoing battery arrays, the first interlocking feature is a groove.

In a further non-limiting embodiment of any of the foregoing battery arrays, each of the first end plate and the second end plate includes a first interlocking feature that is configured to interlock with a second interlocking feature of a wall of the array housing.

In a further non-limiting embodiment of any of the foregoing battery arrays, the wall is part of a bottom cover of the array housing.

A method for assembling a battery array according to another exemplary aspect of the present disclosure includes, among other things, positioning a compression fixture within a channel of an end plate of a cell stack, applying a compressive force to the end plate with the compression fixture, the compressive force sufficient to compress the cell stack, positioning the cell stack within a bottom cover of an array housing, and positioning a top cover of the array housing over the cell stack.

In a further non-limiting embodiment of the foregoing method, the method includes, subsequent to positioning the cell stack within the bottom cover, removing the compression fixture from the channel.

In a further non-limiting embodiment of either of the foregoing methods, after positioning the cell stack within the bottom cover, a first interlocking feature of the end plate engages a second interlocking feature of the array housing to prevent the cell stack from backing out of the bottom cover.

In a further non-limiting embodiment of any of the foregoing methods, positioning the top cover includes compressing an upper portion of the cell stack via a contact between a sloped wall of the top cover and an angled surface of the end plate.

In a further non-limiting embodiment of any of the foregoing methods, the channel is formed within the angled surface.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is a perspective view of an exemplary battery array of a traction battery pack.

FIG. 3 is an exploded view of the battery array of FIG. 2.

FIG. 4 is a cross-sectional view through section 4-4 of FIG. 2.

FIG. 5 is a blown-up view of a select portion of the battery array shown in FIG. 4.

FIG. 6 illustrates an exemplary end plate of a battery array.

FIG. 7 is a blown-up of a select portion of the end plate shown in FIG. 6.

FIG. 8 illustrates another exemplary end plate.

FIG. 9 illustrates another exemplary end plate.

FIG. 10 illustrates yet another exemplary end plate.

FIG. 10A illustrates an interface between an end plate and an array housing.

FIGS. 11, 12, 13, 14, and 15 schematically illustrate an exemplary method for assembling a battery array of a traction battery pack.

### DETAILED DESCRIPTION

This disclosure details battery array end plate designs for use within traction battery packs. An exemplary battery array of the traction battery pack may include features that facilitate a battery array assembly process. These features include channels for accommodating a compression fixture, interlocking features (ribs, bumps, pins, etc.) for engaging corresponding features of an array housing, and angled walls for compressing an upper portion of a cell stack during the battery array assembly process. These and other features are discussed in greater detail in the following paragraphs of this detailed description.

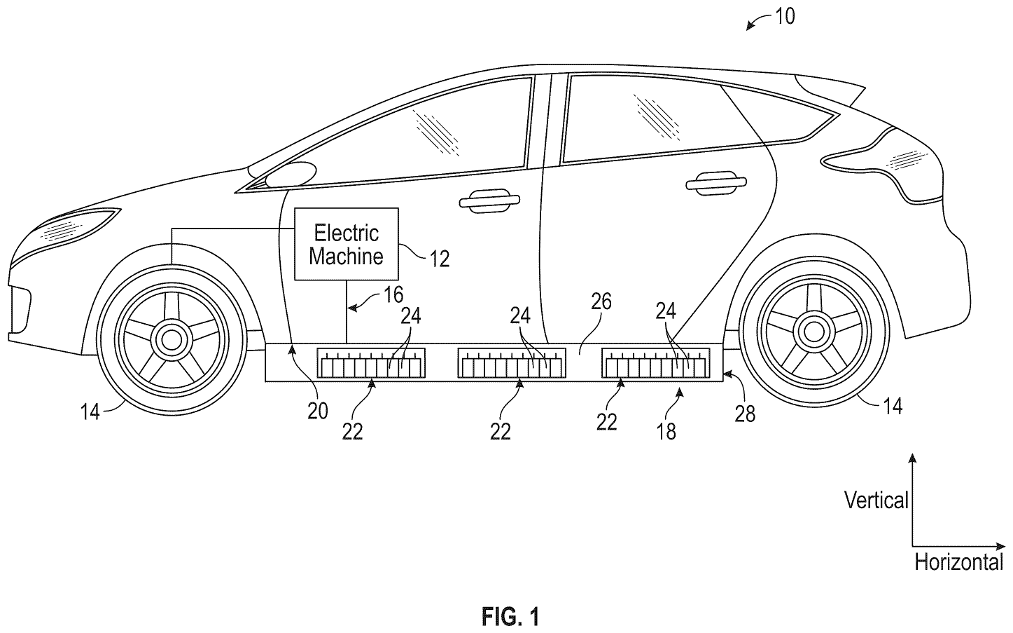

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

The traction battery pack 18 may include one or more battery arrays 22 (e.g., battery modules, assemblies, or groupings of rechargeable battery cells 24) capable of outputting electrical power to power the electric machine 12 and/or other electrical loads of the electrified vehicle 10. The one or more battery arrays 22 of the traction battery pack 18 may each include a plurality of battery cells 24 that store energy for powering various electrical loads of the electrified vehicle 10. The traction battery pack 18 could employ any number of battery arrays 22 and battery cells 24 within the scope of this disclosure. Accordingly, this disclosure should not be limited to the highly schematic configuration shown in FIG. 1.

In an embodiment, the battery cells 24 of each battery array 22 are lithium-ion pouch cells. However, battery cells having other geometries (cylindrical, prismatic, etc.), other chemistries (nickel-metal hydride, lead-acid, etc.), or both could alternatively be utilized within the scope of this disclosure.

The battery arrays 22 and various other battery internal components (e.g., bussed electrical center, battery electric control module, wiring, connectors, etc.) may be housed within an interior area 26 of an enclosure assembly 28. The enclosure assembly 28 may include an enclosure cover and an enclosure tray, for example. The enclosure cover may be secured (e.g., bolted, welded, adhered, etc.) to the enclosure tray to provide the interior area 26. The size, shape, and overall configuration of the enclosure assembly 28 is not intended to limit this disclosure.

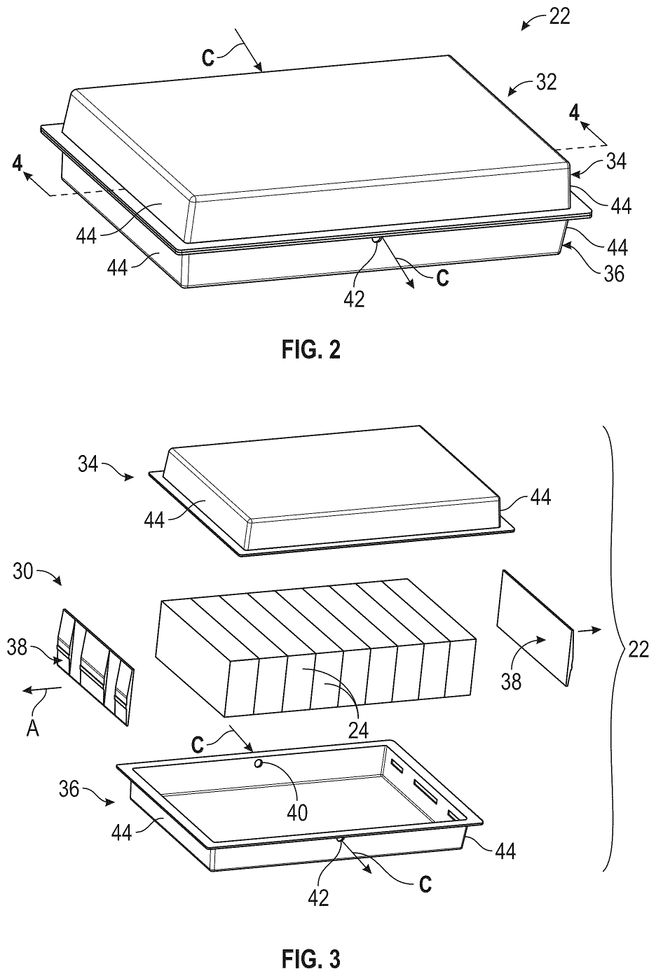

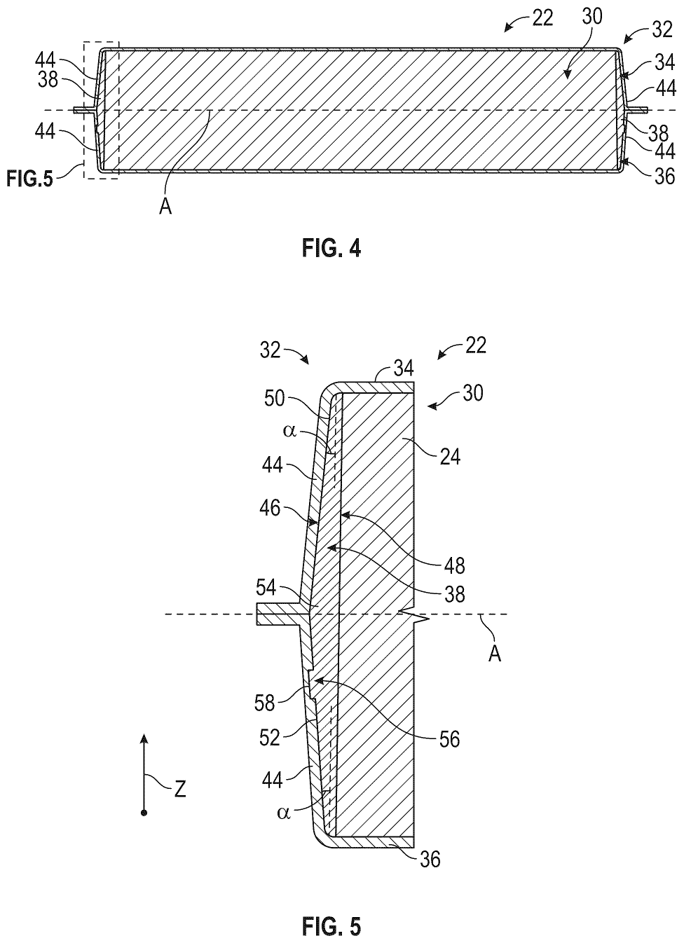

FIGS. 2-5 illustrate a battery array 22 for a traction battery pack. For example, the traction battery pack 18 of the electrified vehicle 10 of FIG. 1 could include one or more battery arrays having a design substantially similar to that of the battery array 22 shown in FIGS. 2-5.

The battery array 22 may include one or more cell stacks 30 housed within an array housing 32. The array housing 32 may include a top cover 34 and a bottom cover 36. The top cover 34 may be positioned vertically above the bottom cover 36. Various terms such as “above,” “below,” “top,” and “bottom” are used relative to the arrangement of the components of the traction battery pack 18 in the various drawings and should not otherwise be deemed limiting. These terms are with reference to the general orientation of the traction battery pack 18 when installed on the electrified vehicle 10 of FIG. 1. Vertical, for purposes of this disclosure, is also with reference to ground and how the traction battery pack 18 is oriented when installed on the electrified vehicle 10.

The top cover 34 may be secured (e.g., bolted, welded, adhered, etc.) to the bottom cover 36 to provide a sealed enclosure for housing the cell stack 30. The size, shape, and configuration of the array housing 32 may vary within the scope of this disclosure.

The cell stack 30 may include a plurality of individual battery cells 24 that are arranged together along a cell stack axis A between opposing end plates 38. Although a single cell stack 30 having and a specific number of battery cells 24 is illustrated in the figures of this disclosure, the battery array 22 could include any number of cell stacks 30, with each cell stack 30 having any number of individual battery cells 24.

Thermal energy levels of the battery cells 24 of the battery array 22 can increase as the electrified vehicle 10 is operated. A thermal management system can be employed for managing the thermal energy levels of the battery cells 24 of the battery array 22. The thermal management system may be configured to route a coolant C through the battery array 22 in order to manage the thermal energy within the battery array 22 by, for example, using the coolant C to take on heat from the battery cells 24 of the cell stack 30.

In an embodiment, the thermal management system is an immersion thermal management system in which portions of the cell stack 30, here at least portions of the battery cells 24, for example, can be immersed in the coolant C. Thermal energy can transfer between the coolant C and the battery cells 24 as the coolant C flows over and/or around the battery cells 24 inside the array housing 32. The coolant C can help manage thermal energy levels of the battery cells 24 as well as other components of the battery array 22.

The thermal management system can deliver the coolant C to the interior area of the battery array 22 through an inlet 40 of the array housing 32. The coolant C can fill one or more open areas inside the battery array 22 such that the battery cells 24 are immersed in, and directly contacted by, the coolant C. The coolant C can take on thermal energy from the battery cells 24 for managing the thermal energy levels. The coolant C may exit the battery array 22 through an outlet 42 of the array housing 32. In an embodiment, both the inlet 40 and the outlet 42 are formed through the bottom cover 36 of the array housing 32. However, other inlet 40 and/or outlet 42 locations are contemplated within the scope of this disclosure.

The coolant C exiting through the outlet 42 can move to a thermal energy exchange device (not shown), such as a heat exchanger, where thermal energy can be transferred from the coolant C to atmosphere. A pump (not shown) can be operated to selectively circulate the coolant C between the battery array 22 and the thermal energy exchange device and then back to the battery array 22.

The coolant C circulated in the immersion thermal management system may be a dielectric fluid or another type of non-conductive fluid (e.g., oil) that is designed for immersion cooling the battery cells 24. However, other non-conductive fluids may also be suitable, and the actual chemical make-up and design characteristics (e.g., dielectric constant, maximum breakdown strength, boiling point, etc.) may vary depending on the environment the battery array 22 is to be employed within.

In another embodiment, the thermal management system is a conventional cold plate system in which the coolant C, such as glycol, is circulated through a cold plate (not shown) in order to thermally manage heat generated by the battery cells 24. The teachings of this disclosure are therefore not limited to battery arrays having immersion thermal management systems. The battery cells 24 are not immersed in the coolant C in the cold plate type of thermal management system.

One or more walls 44 of the array housing 32 may include a draft angle α (see FIG. 5) and therefore may not exhibit a profile that neatly accommodates the sum of the battery cells 24 of the cell stack 30. The walls 44 may be part of the bottom cover 36, the top cover 34, or both. In an embodiment, the draft angle α is between about 3 degrees and about 5 degrees and can be the result of a casting process used to form the top cover 34 and the bottom cover 36 of the array housing 32. However, the actual draft angle α could vary per design requirements and based on the type of manufacturing process being used to form the array housing 32, among other design criteria.

Each end plate 38 may establish an interface that translates or “squares” the draft angle α of the wall(s) 44 of the array housing 32 relative to the cell stack 30. The end plates 38 thus fill in gaps between the opposing ends of cell stack 30 and the array housing 32 and can uniformly transfer battery cell expansion forces from the cell stack 30 to the array housing 32.

In an embodiment, a cross-sectional shape of each end plate 38 is substantially triangular. However, other cross-sectional shapes are contemplated within the scope of this disclosure. In this disclosure, the term “substantially” means that the recited characteristic, parameter, or value need not be achieved exactly, but that deviations or variations, including for example, tolerances, hysteresis, measurement error, measurement accuracy limitations, etc. known to those of ordinary skill in the art could occur in amounts that do not preclude the effect the characteristic was intended to provide.

FIGS. 5-7, with continued reference to FIGS. 2-4, illustrate additional details associated with the end plates 38 of the cell stack 30. As further described below, in addition to providing the cell stack-to-array housing interface described above, each end plate 38 may include features designed to facilitate a battery array assembly process.

Each end plate 38 may include a first side face 46 and a second side face 48 located on an opposite side of the end plate 38 from the first side face 46. In an assembled condition of the battery array 22, the first side face 46 of the end plate 38 faces toward and interfaces with the array housing 32, and the second side face 48 faces toward and interfaces with one of the battery cells 24 located at a longitudinal extent of the cell stack 30.

The first side face 46 may include a first profile, and the second side face 48 may include a second, different profile. The first profile of the first side face 46 may be configured to at least partially match the profile of the draft angle α of the wall 44 of the array housing 32, and the second profile of the second side face 48 may be configured to match the profile of a major side face of one of the battery cells 24 of the cell stack 30. Accordingly, in the exemplary embodiment, the first side face 46 includes a sloped or angled profile, and the second side face 48 includes a substantially flat profile.

The first side face 46 of the end plate 38 may include a first angled surface 50 and a second angled surface 52. The first and second angled surfaces 50, 52 may converge together at an apex 54 of the first side face 46. The apex 54 may be located at or near a mid-point (e.g., along a vertical or Z-axis) of the first side face 46. In an embodiment, the first angled surface 50 may be angled to match the profile of the draft angle α of the wall 44 of the top cover 34, and the second angled surface 52 may be angled to match the profile of the draft angle α of the wall 44 of the bottom cover 36.

The end plate 38 may include features that facilitate an interlocking connection between the cell stack 30 and the array housing 32. For example, the first side face 46 of the end plate 38 may include one or more first interlocking features 56 that are configured to interlock with a second interlocking feature 58 provided by the wall 44 of the bottom cover 36 of the array housing 32. The first interlocking features 56 may engage the second interlocking features 58 to retain the Z-axis position of the cell stack 30 during and after installation of the cell stack 30 within the bottom cover 36 of the array housing 32.

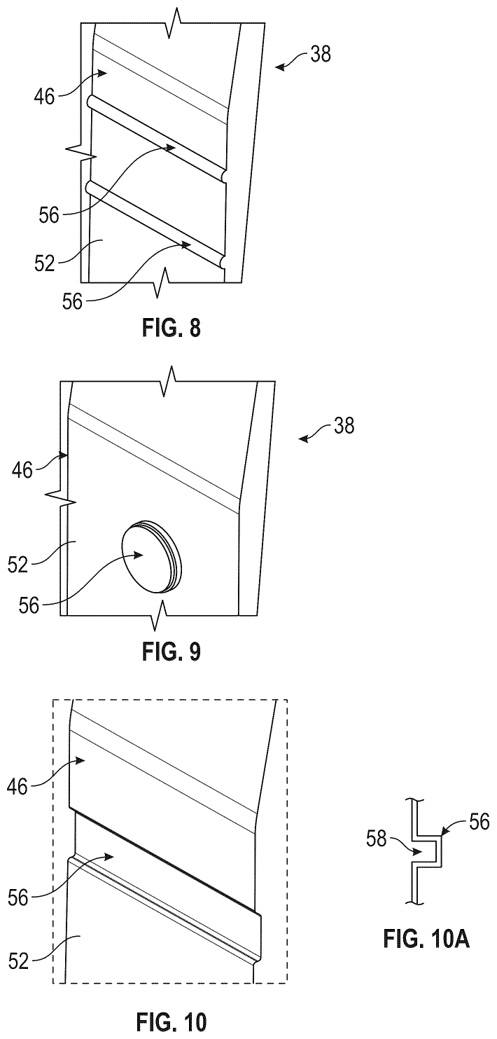

In an embodiment, the first interlocking features 56 are configured as raised ledges that protrude outwardly from the second angled surface 52 of the first side face 46 of the end plate 38, and the second interlocking features 58 are configured as grooves formed in the wall 44 of the bottom cover 36 (see e.g., FIGS. 5-7). In another embodiment, the first interlocking features 56 are configured as raised ribs that protrude outwardly from the second angled surface 52 of the first side face 46 of the end plate 38 (see, e.g., FIG. 8). In another embodiment, the first interlocking features 56 are configured as dimples that protrude outwardly from the second angled surface 52 of the first side face 46 of the end plate 38 (see, e.g., FIG. 9). In yet another embodiment, the first interlocking features 56 are configured as grooves that protrude inwardly from the second angled surface 52 of the first side face 46 of the end plate 38 (see, e.g., FIG. 10) and that are sized to receive second interlocking features 58 that are configured as protruding ledges or ribs of the array housing 32 (see, e.g., FIG. 10A). The first interlocking feature 56 can therefore provide either the male portion or the female portion of the interlocking connection between the end plate 38 and the array housing 32. Notably, the size, shape, location and number of each of the first interlocking features 56 and the second interlocking feature 58 may depend on the design requirements of the battery array assembly, among other factors. Other implementations could include any combination of the interlocking features shown in FIGS. 5-10.

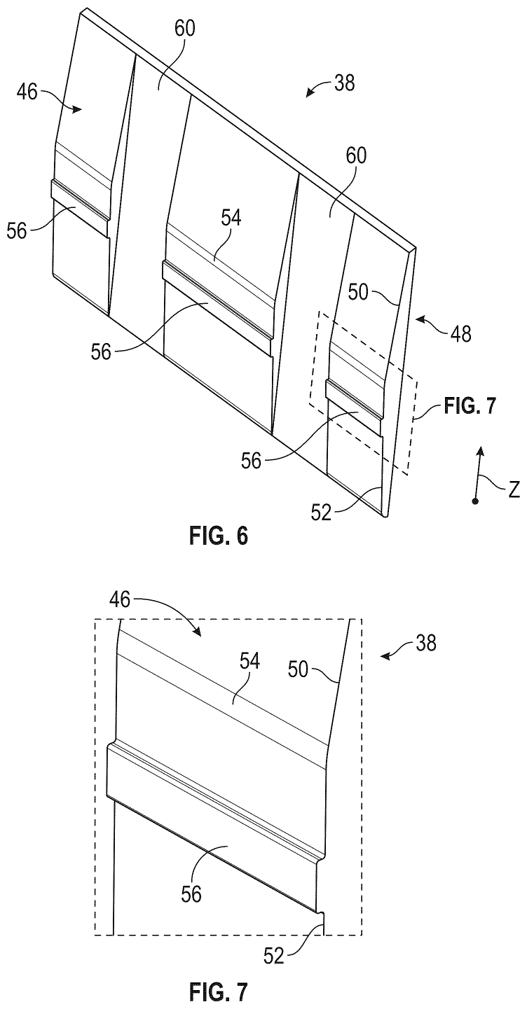

The end plate 38 may additionally include features for accommodating compression jigs or fixtures of a compression machine that can be used to compress the cell stack 30 along the cell stack axis A prior to its insertion into the bottom cover 36 of the array housing 32, such as during a battery array assembly procedure. For example, as best shown in FIG. 6, the first side face 46 of the end plate 38 may include one or more channels 60 that are sized to receive a compression fixture of a compression machine. Each channel 60 may extend along the Z-axis of the end plate 38 and can extend across an entire height of the end plate 38.

In some implementations, each channel 60 may separate adjacent first interlocking feature 56 of the end plate 38 from one another along a width of the first side face 46. In an embodiment, the channels 60 extend along axes that are transverse to axes of the first interlocking features 56. However, other configurations are contemplated within the scope of this disclosure. Notably, the size, shape, location and number of channels 60 provided by the end plate 38 may depend on the design requirements of the battery array assembly, among other factors.

In an embodiment, the end plates 38 are polymer-based components. In another embodiment, the end plates 38 are metallic-based components. The end plates 38 could be formed using any manufacturing technique.

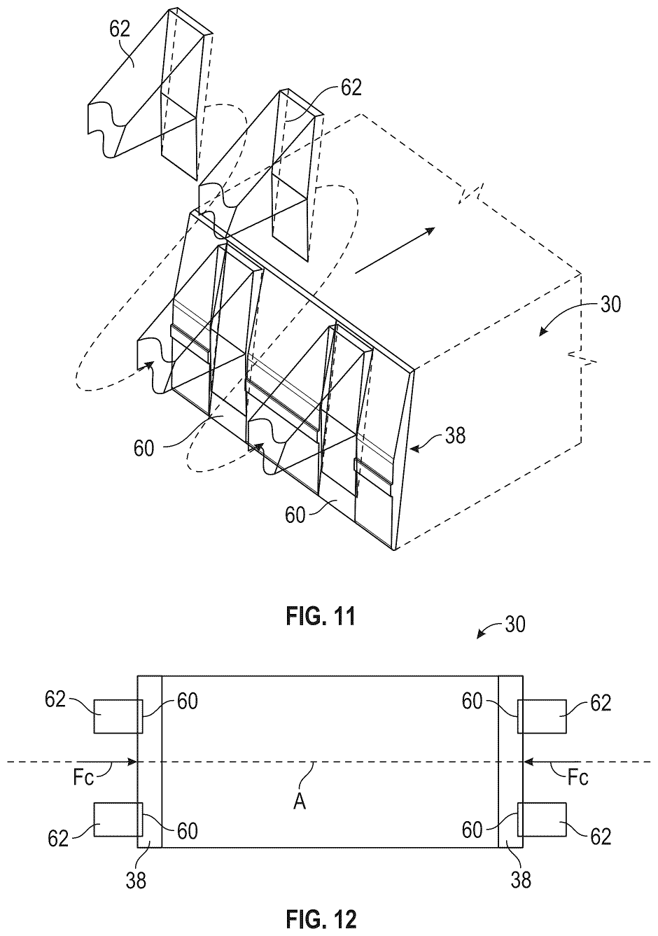

FIGS. 11-15, with continued reference to FIGS. 1-10, schematically illustrate a method for assembling the battery array 22 described above. First, as shown in FIG. 11, a compression fixture 62 may be positioned to engage each channel 60 of each end plate 38 of the cell stack 30. The compression fixtures 62 may be connected to a common compression machine (not shown) or to different compression machines within the scope of this disclosure. Although only a single end plate 38 is shown in FIG. 11 for simplicity, it should be appreciated that additional compression fixtures 62 could simultaneously be utilized to engage each channel 60 of the opposite end plate 38 of the cell stack 30.

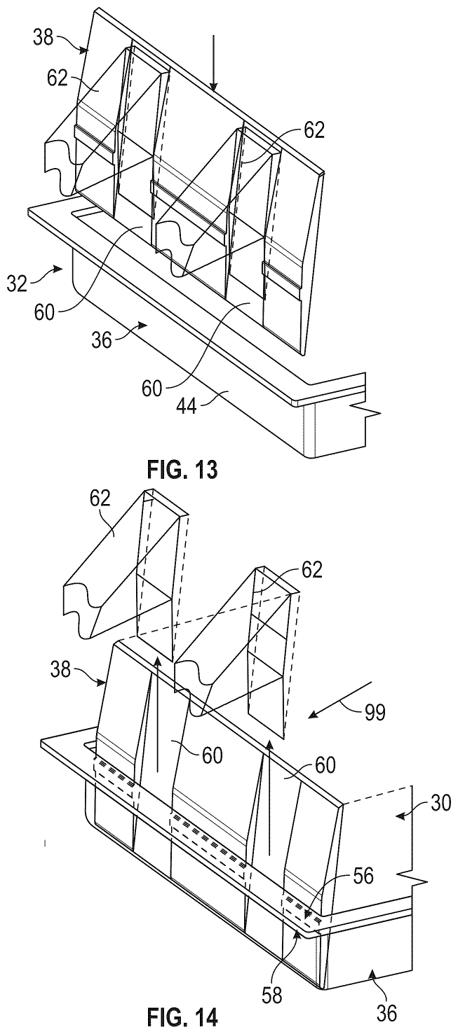

Next, as shown in FIG. 12, the compression fixtures 62 can be moved to compress the battery cells 24 along the cell stack axis A of the cell stack 30. For example, a pneumatic actuator of the compression machine could drive the compression fixtures 62 positioned on opposing ends of the cell stack 30 toward one another to apply a compressive force F_{c} to each opposing end plate 38 and thereby compress the battery cells 24 along the cell stack axis A. The compressive forces F_{C} essentially squeeze the cell stack 30, thereby compressing the battery cells 24, and thus the cell stack 30, to a reduced thickness.

While maintaining the compressive forces F_{C} applied at each opposing end plate 38, the cell stack 30 may be inserted into the bottom cover 36 of the array housing 32 (see FIG. 13). The compression fixtures 62 may then be removed from the channels 60 (see FIG. 14). Upon removing the compression fixtures 62, the cell stack 30 may slightly expand outwardly (e.g., in a direction of arrow 99 in FIG. 14), thus allowing the first interlocking features 56 of the end plates 38 to engage the second interlocking features 58 of the bottom cover 36 and substantially prevent the cell stack 30 from backing out of the bottom cover 36 along the Z-axis.

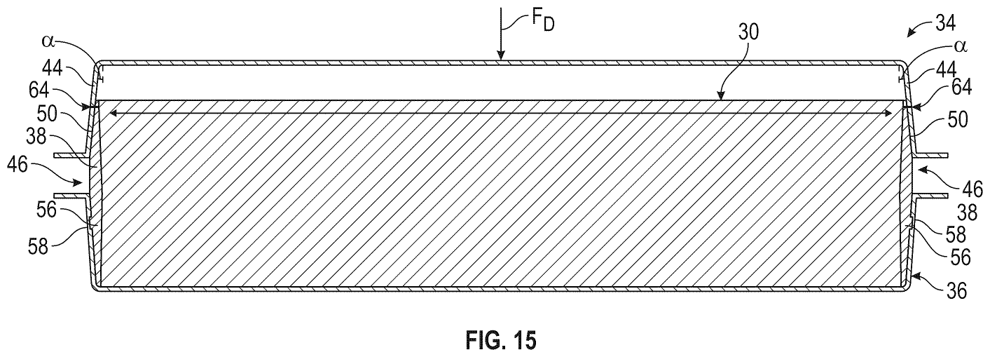

Finally, as shown in FIG. 15, the top cover 34 may be installed over the cell stack 30. When installing the top cover 34, the first angled surface 50 of the first side face 46 of each end plate 38 may interact with the draft angle α of the wall 44 of the top cover 34. Accordingly, as the top cover 34 is moved further toward the bottom cover 36, such as via a downward force F_{D}, contact (schematically shown at reference numerals 64) between the angled walls 44 of the top cover 34 and the first angled surfaces 50 may partially re-compress an upper portion of the cell stack 30 to the extent some battery cell expansion occurs after removing the compression fixtures 62. The top cover 34 may be secured to the bottom cover 36 in any manner to seal the array housing 32 about the cell stack 30.

The exemplary battery arrays of this disclosure include end plates with novel features for facilitating a battery array assembly process. For example, the end plates may include features such as channels for accommodating a compression fixture, interlocking features (ribs, bumps, pins, etc.) for engaging corresponding features of an array housing, and angled walls for compressing an upper portion of a cell stack during the battery array assembly process.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A battery array for a traction battery pack, comprising:
an array housing; and
a cell stack housed within the array housing and including a plurality of battery cells arranged between a first end plate and a second end plate,
wherein each of the first end plate and the second end plate includes a channel configured to receive a compression fixture.

2. The battery array as recited in claim 1, wherein the first end plate establishes an interface between a draft angle of a wall of the array housing and the cell stack.

3. The battery array as recited in claim 2, wherein the first end plate includes a first side face that interfaces with the wall, and a second side face that interfaces with a first battery cell of the plurality of battery cells.

4. The battery array as recited in claim 3, wherein the first side face includes a first profile and the second side face includes a second, different profile.

5. The battery array as recited in claim 4, wherein the first profile is sloped or angled, and the second, different profile is flat.

6. The battery array as recited in claim 3, wherein the channel is formed in the first side face of the first end plate.

7. The battery array as recited in claim 3, wherein the first side face includes a first angled surface and a second angled surface that converge together at an apex of the first side face.

8. The battery array as recited in claim 7, wherein the channel spans across the first angled surface and the second angled surface.

9. The battery array as recited in claim 3, wherein the first side face includes a first interlocking feature that is configured to engage a second interlocking feature of the wall.

10. The battery array as recited in claim 9, wherein the first interlocking feature is a raised ledge.

11. The battery array as recited in claim 9, wherein the first interlocking feature is a rib.

12. The battery array as recited in claim 9, wherein the first interlocking feature is a dimple.

13. The battery array as recited in claim 9, wherein the first interlocking feature is a groove.

14. The battery array as recited in claim 1, wherein each of the first end plate and the second end plate includes a first interlocking feature that is configured to interlock with a second interlocking feature of a wall of the array housing.

15. The battery array as recited in claim 14, wherein the wall is part of a bottom cover of the array housing.

16. A method for assembling a battery array, comprising:
positioning a compression fixture within a channel of an end plate of a cell stack;
applying a compressive force to the end plate with the compression fixture, the compressive force sufficient to compress the cell stack;
positioning the cell stack within a bottom cover of an array housing; and
positioning a top cover of the array housing over the cell stack.

17. The method as recited in claim 16, comprising, subsequent to positioning the cell stack within the bottom cover:
removing the compression fixture from the channel.

18. The method as recited in claim 16, wherein, after positioning the cell stack within the bottom cover, a first interlocking feature of the end plate engages a second interlocking feature of the array housing to prevent the cell stack from backing out of the bottom cover.

19. The method as recited in claim 16, wherein positioning the top cover includes:
compressing an upper portion of the cell stack via a contact between a sloped wall of the top cover and an angled surface of the end plate.

20. The method as recited in claim 19, wherein the channel is formed within the angled surface.
